(19) United States
(12) Patent Application Publication
(10) Pub. No.: US 2016/0059564 A1
(43) Pub. Date: Mar. 3, 2016

(54) INKJET APPARATUS THAT CONTROLS A FLOW RATE OF LIQUID CIRCULATED THEREIN

(71) Applicant: TOSHIBA TEC KAUBSHIKI KAISHA, Tokyo (JP)

(72) Inventors: Kazuhiko OHTSU, Mishima Shizuoka (JP); Kazuhiro HARA, Numazu Shizuoka (JP); Yasushi KURIBAYASHI, Mishima Shizuoka (JP); Yoshiaki KANEKO, Mishima Shizuoka (JP); Hiroyuki ISHIKAWA, Tagata Shizuoka (JP)

(21) Appl. No.: 14/823,936

(22) Filed: Aug. 11, 2015

(30) Foreign Application Priority Data
Sep. 1, 2014 (JP) 2014-177366

(51) Int. Cl. B41J 2/175

(52) U.S. Cl. CPC B41J 2/175

(57) ABSTRACT

An inkjet apparatus includes a head configured to discharge liquid through a plurality of nozzles, a tank configured to store the liquid, a circulation device positioned between the tank and the head and including a supply passage by which the liquid is circulated from the tank to the head and a return passage by which the liquid is circulated from the head to the tank, a temperature detecting unit configured to detect a temperature of the circulated liquid, and a control unit configured to control a flow rate of the circulated liquid, based on a detection result of the temperature detecting unit.

### CROSS-REFERENCE TO RELATED APPLICATION

This application is based upon and claims the benefit of priority from Japanese Patent Application No. 2014-177366, filed Sep. 1, 2014, the entire contents of which are incorporated herein by reference.

### FIELD

Embodiments described herein relate generally to an inkjet apparatus, in particular an inkjet apparatus that controls a flow rate of liquid circulated therein.

### BACKGROUND

An ink jet device ejects ink to a medium to form an image. An inkjet device of one type includes an ink circulating unit between an ink jet head and an ink cartridge. The ink circulating unit removes air bubbles or foreign substances included in the ink. An ink circulating device of another type includes a heating device (heater) or a cooling device (cooler) to maintain the temperature of the ink at a desired level, so that ink droplets maybe more stably ejected. For this reason, many ink jet devices include the ink circulating device.

When the temperature of the ink is lower than a predetermined value, the inkjet device cannot start printing. To start the printing, it is necessary to carryout a so-called warming-up process until the temperature reaches the predetermined value by heating the ink by the heating device. The warming-up time may vary depending on the season or the size of the heating device provided in the ink circulating device. In any case, it is desirable to shorten the warming-up time without compromising stability of ink discharging.

### DESCRIPTION OF THE DRAWINGS

FIG. 1 is a front view of an ink jet device according to an embodiment.

FIG. 2 is a plan view of the ink jet device of FIG. 1.

FIGS. 3A and 3B are schematic views of a nozzle portion of the ink jet device of FIG. 1.

FIG. 4 schematically illustrates a flow path of ink in an ink jet head of the ink jet device of FIG. 1.

FIG. 5A is a perspective view of an ink jet unit of the ink jet device of FIG. 1.

FIG. 5B is a perspective view when the inkjet unit from a direction opposite to the direction of FIG. 5A.

FIG. 6 schematically illustrates a structure of the ink jet unit of FIG. 5A.

FIG. 7 is a schematic view of a piezoelectric pump which is used in the ink jet unit of FIG. 5A.

FIG. 8 is a cross-sectional view of the piezoelectric pump cut along line A-A of FIG. 7.

FIG. 9 is a block diagram of the ink jet device of FIG. 1.

FIG. 10 is a graph illustrating a relationship between temperature of the ink and viscosity of the ink.

FIG. 11 is a graph illustrating a relationship between the viscosity of the ink and an ejection speed of the ink.

FIG. 12 is a graph illustrating a relationship between a circulating flow rate of the ink and the ejection speed of the ink.

FIG. 13 is a flowchart of an operation to control the ejection speed of the ink based on the temperature of the ink.

FIG. 14 is an example of a control table illustrating a relationship between the temperature of the ink and a flow rate of the ink when the ejection speed is set as 9 m/s.

### DETAILED DESCRIPTION

In general, according to an embodiment, an inkjet apparatus includes a head configured to discharge liquid through a plurality of nozzles, a tank configured to store the liquid, a circulation device positioned between the tank and the head and including a supply passage by which the liquid is circulated from the tank to the head and a return passage by which the liquid is circulated from the head to the tank, a temperature detecting unit configured to detect a temperature of the circulated liquid, and a control unit configured to control a flow rate of the circulated liquid, based on a detection result of the temperature detecting unit.

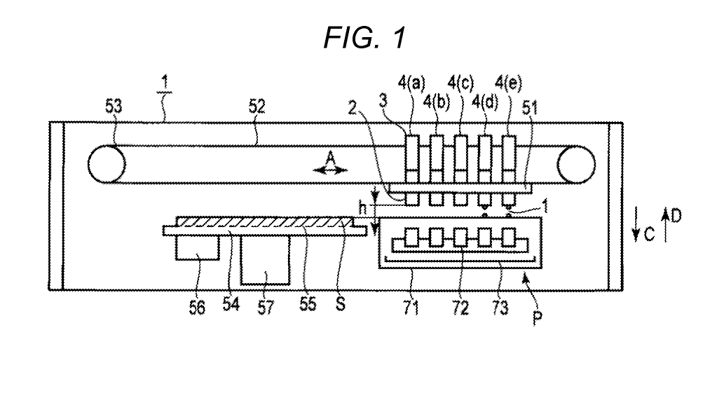

Hereinafter, an embodiment will be described with reference to the drawings. FIG. 1 is a front view of an ink jet device 1.

The ink jet device 1 includes a plurality of ink jet units 4. Each of the ink jet units 4 includes an ink jet head 2 and an ink circulating device 3. The ink jet units 4(a) to 4(e) are arranged on a carriage 51 in parallel to each other and the number thereof corresponds to the number of colors to be used. The ink jet head 2 contains ink I therein, and ejects the ink I from a nozzle 62 which is provided on a nozzle plate 61 in accordance with an image forming signal. The ink circulating device 3 supplies the ink I to the ink jet head 2, recovers the ink I which is not discharged from the nozzle 62 and remains, and again, supplies the recovered ink I to the ink jet head 2 and makes the ink I circulate. For example, in a direction of gravity, the ink jet unit 4(a) includes the ink jet head 2 which ejects the ink I downward, and the ink circulating device 3 in an upper unit thereof. The ink jet units 4(b) to 4(e) have the same configuration as the ink jet unit 4(a).

The ink jet unit 4(a) ejects cyan ink, the ink jet unit 4(b) ejects magenta ink, the ink jet unit 4(c) ejects yellow ink, and the ink jet unit 4(d) ejects black ink. The ink jet unit 4(e) ejects white ink, transparent glossy ink, or special ink which generates color when being irradiated with an infrared ray or an ultraviolet ray. The carriage 51 on which the ink jet units 4(a) to 4(e) are mounted is fixed to a conveying belt 52. The conveying belt 52 is connected to a motor 53. The carriage 51 reciprocates in a direction of an arrow A as the motor 53 is driven forward or rearward. Each of the ink jet units 4(a) to 4(e) illustrated in FIG. 1 ejects the corresponding ink I in the direction of gravity (direction of an arrow C).

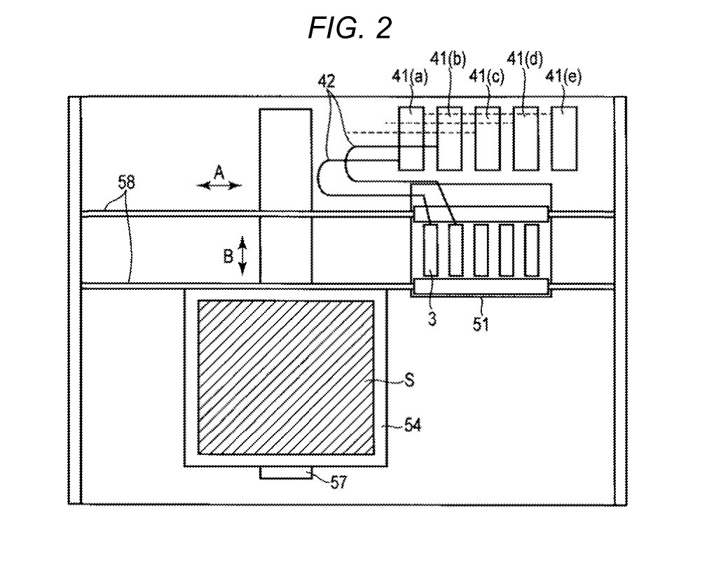

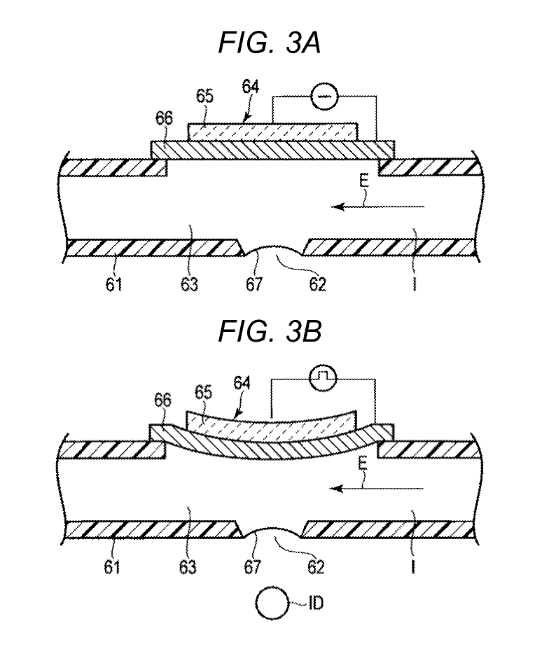

A table 54 is a container having a plurality of holes 55 each having a small-diameter is formed on an upper surface thereof. The table 54 fixes a medium S which is mounted on the upper surface when a pressure in the container is caused to be negative by a pump 56. The medium S is a paper sheet, a film which is made of a resin or a metal, or a plate material. The table 54 is attached onto a slide rail 57, and reciprocates in a direction of an arrow B illustrated in FIG. 2. The ink jet head 2 includes the nozzle plate 61 on which the plurality of nozzles 62 (refer to FIGS. 3A and 3B) which ejects the ink I is formed. While the ink jet head 2 reciprocates, a distance h between the nozzle plate 61 and the medium S is maintained to be constant. The ink jet head 2 has 300 to 600 nozzles in a depth direction (longitudinal direction) of FIG. 1. The ink jet device 1 forms an image by reciprocate the ink jet units 4(a) and 4(b) in a direction orthogonal to a conveying direction of the medium S. In other words, the longitudinal direction in which approximately 300 to 600 nozzles 62 of the ink jet head 2 are arranged, is the same as the conveying direction of the medium S. The ink jet device 1 forms the image on the medium S by ejecting the ink I from the nozzles 62 that are adjacent to each other onto the nozzle plate 61.

A maintenance unit 71 is arranged at a position outside a moving range of the table 54 in a scanning range in an A direction of the ink jet units 4(a) to 4(e). A waiting position P of the inkjet head 2 is a position at which the maintenance unit 71 and the ink jet head 2 confront each other.

The maintenance unit 71 may move vertically (directions of arrows C and D in FIG. 1) and include a case which is opened upward. The maintenance unit 71 moves in the C direction downward and waits when the carriage 51 moves in the direction of the arrow A. When an image forming operation is finished, the ink jet head 2 returns to the waiting position P. The maintenance unit 71 moves in the D direction upward and covers the nozzle plate 61 of the ink jet head 2 at the waiting position P. The maintenance unit 71 prevents (capping function) the ink I from evaporating and dust or paper powder from adhering to the nozzle plate 61.

The maintenance unit 71 includes a blade 72. The blade 72 removes the ink I, dust, or paper powder which adhere to the nozzle plate 61 of the ink jet head 2. For example, the blade 72 is formed of rubber, which is one of elastic materials. When the carriage 51 moves in the direction of the arrow A, the blade 72 moves in the C direction downward together with the maintenance unit 71, and is separated from the nozzle plate 61. Meanwhile, the blade 72 moves in the D direction upward when the ink I, dust, or paper powder which adhere to the nozzle plate 61 is removed, and comes into contact with the nozzle plate 61. The maintenance unit 71 has a mechanism which may move the blade 72 in the B direction (refer to FIG. 2). The blade 72 wipes out a surface of the nozzle plate 61 using a mechanism which moves the blade 72 in the B direction, and removes (wiping function) the ink I, dust, or paper powder.

The maintenance unit 71 includes a waste ink receiving unit 73. The waste ink receiving unit 73 stores the ink I which is forcibly discharged from the nozzle 62 when the maintenance operation is performed and the deteriorated ink in the vicinity of the nozzle 62. The waste ink receiving unit 73 stores waste ink generated from wiping by the blade 72 and waste ink forcibly discharged from the nozzle 62.

FIG. 2 is a plan view of the ink jet device 1.

The carriage 51 reciprocates in the A direction along two rails 58 by movement of the conveying belt 52. The table 54 reciprocates in the B direction. The medium S is mounted on the table 54. The ink jet device 1 causes the carriage 51 on which the ink jet unit 4 is mounted and the table 54 on which the medium S is put to reciprocate in accordance with an image signal. In addition, the ink jet device 1 ejects the ink I from the nozzle 62, and forms an image on the entire surface of the medium S. The ink jet device 1 is a so-called serial type ink jet device.

The ink jet units 4(a), 4(b), 4(c), 4(d), and 4(e) respectively communicate with corresponding ink cartridges 41(a), 41(b), 41(c), 41(d), and 41(e) via a tube 42.

For example, the ink cartridge 41(a) is filled with the cyan ink, and communicates with the ink jet unit 4(a) via the tube 42. The ink cartridge 41(b) is filled with the magenta ink, and communicates with the ink jet unit 4(b) via the tube 42. The ink cartridge 41(c) is filled with the yellow ink, and communicates with the ink jet unit 4(c). The ink cartridge 41(d) is filled with the black ink, and communicates with the ink jet unit 4(d). The ink cartridge 41(e) is filled with the white ink, and communicates with the ink jet unit 4(e).

The ink jet unit 4 includes the ink jet head 2 and the ink circulating device 3. The ink circulating device 3 is disposed above the ink jet head 2. By stacking the ink circulating device 3 above the ink jet head 2, the ink jet unit 4 may have a narrower space in a direction in which the ink jet units 4(a) to 4(e) are aligned on the carriage 51. For this reason, the inkjet device 1 may shorten the width of the carriage 51 in the conveying direction (A direction). A conveying distance of the carriage 51 in the A direction is a distance which is calculated at least by adding the length which is two times the width of the carriage to the maximum width of the medium S. The inkjet device 1 may be miniaturized as the width of the carriage 51 decreases and the conveying distance decreases.

In addition to the above-described ink jet device 1, which uses the moving table 54, an ink jet device may perform printing while drawing out a rolled paper sheet and moving the ink jet unit to be orthogonal to the rolled paper sheet. Alternatively, an ink jet device may perform printing while sending the paper sheet one by one using a platen roller and moving the ink jet unit to be orthogonal to the paper sheet.

The ink jet head 2 which is employed in the ink jet device 1 will be described.

FIGS. 3A and 3B are cross-sectional views of a portion of the ink jet head 2 which ejects the ink I. The inkjet head 2 includes the nozzle 62 which ejects the ink I. The ink jet head 2 has an ink branching region 63 along an ink flow path. The ink branching region 63 is a region which branches the ink I that flows in a direction of an arrow E into an ink droplet ID which is ejected from the nozzle 62, and the ink I which returns to the ink circulating device 3 from the ink jet head 2. The ink jet head 2 includes an actuator 64 which is on a surface facing the nozzle 62. The actuator 64 includes a unimorph-type piezoelectric diaphragm which had a piezoelectric ceramic 65 and a diaphragm 66 that are stacked. As a material of the piezoelectric ceramic 65, PZT (lead zirconate titanate) is used. The piezoelectric ceramic 65 has electrodes on upper and lower surfaces thereof, and is polarization-processed. The piezoelectric ceramic 65 is bonded to the diaphragm 66 made of silicon nitride, and is used as the actuator 64. In the nozzle 62, a meniscus 67 is formed on an interface between the ink I and the air by surface tension of the ink I.

FIG. 3A illustrates a state in which the actuator 64 is not deformed without an electric field being applied to the piezoelectric ceramic 65. FIG. 3B illustrates a state in which the ink droplet ID is ejected by the electric field being applied to the piezoelectric ceramic 65 and the actuator 64 being deformed. Pressure of the ink I in the ink branching region 63 increases when the piezoelectric ceramic 65 is deformed, and the ink I is ejected from the nozzle 62 as the ink droplet ID.

Instead of the above-described actuator 64, the ink I may be ejected using another configuration in which pressure is applied to the ink I. For example, the diaphragm may be deformed by static electricity and the pressure is given to the ink, the ink may be heated by the heater and the pressure is used when air bubbles are generated in the ink, or any configuration may be used as a pressure generating body.

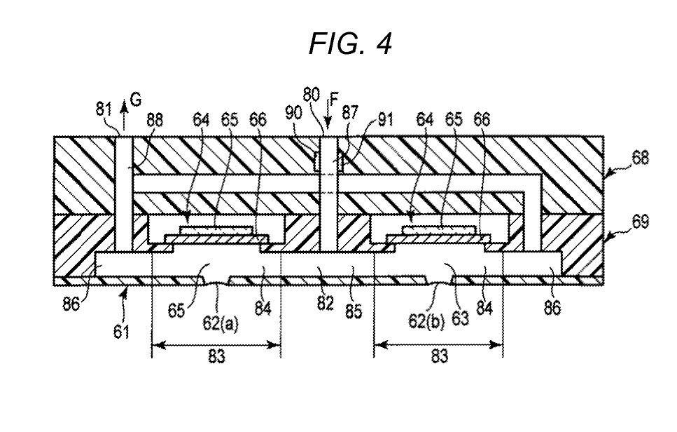

With reference to FIG. 4, a flow of the ink I inside the ink jet head 2 which includes a portion that ejects the ink illustrated in FIGS. 3A and 3B will be described.

The ink jet head 2 includes the nozzle plate 61, a substrate 69 having the actuator 64, and a manifold 68.

The nozzle plate 61 includes a first nozzle row which includes a plurality of nozzles 62(a) that is aligned in the depth direction of FIG. 4, and a second nozzle row which includes a plurality of nozzles 62(b) that is aligned in the depth direction of FIG. 4. As described above, the ink I is ejected through each nozzle 62 (62(a), 62(b)). In other words, the ink jet head 2 is long in the depth direction of FIG. 4, and the nozzles 62(a) and 62(b) are arranged in the longitudinal direction. The plurality of nozzles 62(a) and 62(b) are arranged in the B direction (refer to FIG. 2), and are aligned in a direction which is orthogonal to the moving direction of the carriage 51.

The substrate 69 has a flow path 82 in which the ink I passes through. The flow path 82 is formed between the substrate 69 and the nozzle plate 61 fixed to the substrate 69. The actuator 64 is arranged to face the flow path 82, and correspond to each nozzle 62. The pressure applied to the ink I in the flow path 82 by the actuator 64 is concentrated in the nozzle 62 by a boundary wall 83 provided between the adjacent nozzles 62.

An ink pressure chamber 84 is formed in the flow path 82 which is surrounded by the nozzle plate 61, the actuator 64, and the boundary wall 83. A plurality of ink pressure chambers 84 is formed corresponding to the nozzles 62(a) and 62(b) of the first nozzle row and the second nozzle row. The first nozzle row includes approximately 300 nozzles 62. Similarly, the second nozzle row includes approximately 300 nozzles. The ink pressure chamber 84 has a structure in which the ink I flows from one end, through the ink branching region 63, and to the other end. A portion of the ink I is ejected from the nozzle 62 by the ink branching region 63 in the ink pressure chamber 84, and the ink I which remains in the flow path 82 flows out of the other end.

The flow path 82 between the plurality of ink pressure chambers 84 which is formed corresponding to each nozzle 62(a) in the first nozzle row, and the plurality of ink pressure chambers 84 which is formed corresponding to each nozzle 62(b) in the second nozzle row, is a common ink chamber 85. The common ink chamber 85 communicates with one inlet of the ink pressure chamber 84, and is used to supply the ink I to all of the ink pressure chambers 84.

The ink I which flows out from the other end of the plurality of ink pressure chambers 84, which corresponds to the first nozzle row, and the plurality of ink pressure chambers 84, which corresponds to the second nozzle row, flows into the a common ink chamber 86 which communicates with the first and the second nozzle rows. The common ink chamber 86 is a portion of an ink reflux path 88 which is provided on the substrate 69.

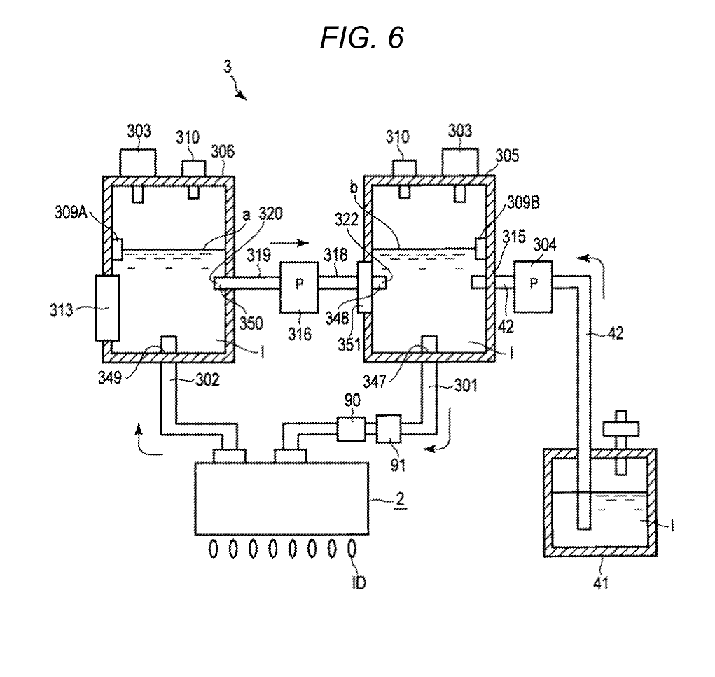

The manifold 68 is fixed to the substrate 69, and used to supply the ink I which passes through an ink distribution path 87 to the flow path 82. The manifold 68 includes an ink supply port 80 through which the ink I flow in a direction of an arrow F, and then through the ink distribution path 87 which communicates with the common ink chamber 86. Along the ink distribution path 87, a temperature sensor 90 for detecting the temperature of the ink supplied to the ink jet head 2, and a flow rate sensor 91 for detecting the flow rate of the ink I supplied to the ink jet head 2 are disposed. Alternatively, the temperature sensor 90 may be disposed along an ink supply pipe 301 (refer to FIG. 6).

In addition, the manifold 68 includes an ink outlet 81 through which the ink I is discharged in a direction of an arrow G, and the ink reflux path 88 which connects the ink outlet 81 to the two common ink chambers 86.

The temperature sensor 90 detects the temperature of the ink I which is supplied into the ink jet head 2. Flow rate of the ink I which circulates in the ink circulating device 3 and the ink jet head 2 is controlled based on the temperature of the ink I in the ink jet head 2.

The ink I flows in the ink jet head 2 in an order of the ink supply port 80, the ink distribution path 87, the common ink chamber 85, the ink pressure chamber 84, the common ink chamber 86, the ink reflux path 88, and the ink outlet 81. A portion of the ink I is ejected from the nozzle 62 according to the image signal, and the remaining ink I flows into the ink circulating device 3 from the ink outlet 81.

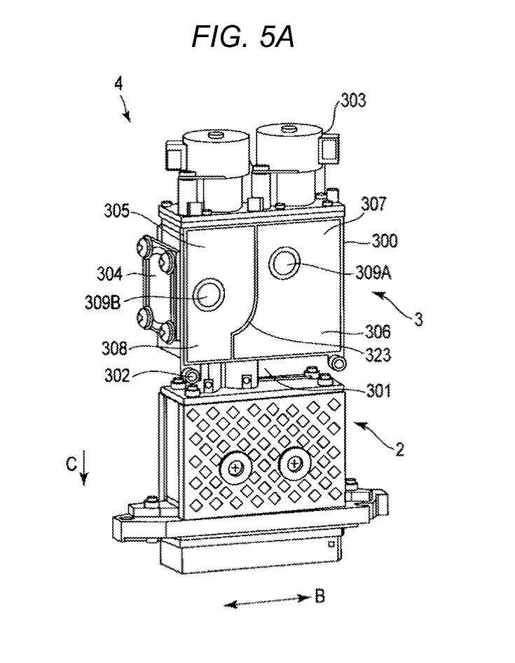

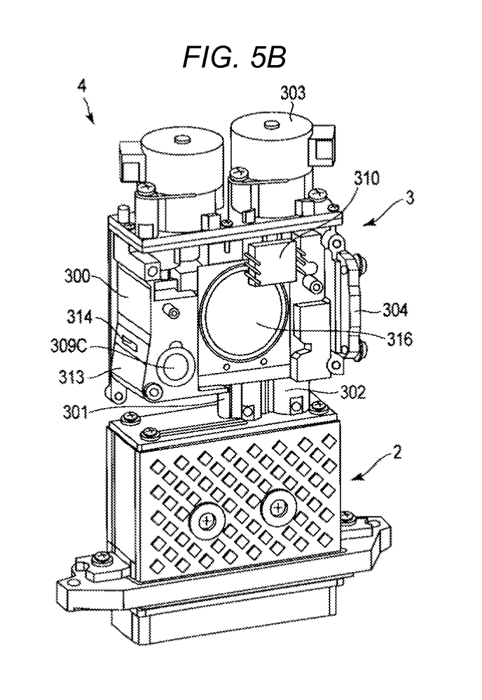

With reference to FIGS. 5A to 8, the ink circulating device 3 will be described.

FIGS. 5A and 5B illustrate the ink jet unit 4 in which the ink circulating device 3 is arranged above the ink jet head 2, and the ink circulating device 3 and the ink jet head 2 are integrated with each other. FIG. 6 schematically illustrates the flow of the ink I in the ink jet unit 4.

The ink circulating device 3 includes an ink casing 300, an ink supply pipe 301 through which the ink I is supplied to the ink jet head 2, an ink returning pipe 302 through which the ink I recovered from the ink jet head 2, and a pressure adjusting unit 303 which adjusts the pressure inside the ink casing 300. The pressure adjusting unit 303 is a pressure adjusting pump. For example, a tube pump or a bellows pump is used. The ink circulating device 3 sends the ink I to the ink jet head 2 (arrow C which is the direction of gravity) at the lower portion through the ink supply pipe 301, and the ink jet head 2 ejects the ink I further downward.

The ink circulating device 3 includes an ink supply pump 304 which supplies the ink I into the ink casing 300 as much as an amount of the ink which is consumed by the printing or the maintenance operation, on an outer wall surface of the ink casing 300. The ink circulating device 3 includes a supply side ink chamber 305, which is a first tank, and a collection side ink chamber 306, which is a second tank, so that the ink I may be reserved inside the ink casing 300. The collection side ink chamber 306 is tightly closed by a first plate 307, and the supply side ink chamber 305 is tightly closed by a second plate 308. The ink supply pump 304 supplies the ink I to the supply side ink chamber 305 from the ink cartridge 41.

As illustrated in FIG. 6, the supply side ink chamber 305 includes an ink replenishing port 315, an outlet 347, and an inlet 348.

The ink replenishing port 315 is disposed to replenish the ink I from the ink cartridge 41 via the tube 42. The outlet 347 is disposed to discharge the ink I to the ink jet head 2 via the ink supply pipe 301. Through the inlet 348, the ink I which is supplied from the collection side ink chamber 306 is introduced into the supply side ink chamber 305.

As illustrated in FIG. 6, the collection side ink chamber 306 includes an inlet 349 and an outlet 350. The inlet 349 is connected to the ink returning pipe 302 through which the ink I that is not discharged as the ink droplet ID is recovered from the ink jet head 2. The outlet 350 is disposed at a position through which the ink I in the collection side ink chamber 306 is supplied to the supply side ink chamber 305.

The ink casing 300 includes ink amount measuring sensors 309A, 309B, and 309C for measuring amount of ink I in the collection side ink chamber 306 and the supply side ink chamber 305.

The ink amount measuring sensor 309A measures the amount of the ink in the collection side ink chamber 306 and is attached to the first plate 307 which tightly closes the ink casing 300. The ink amount measuring sensor 309B measures the amount of the ink in the supply side ink chamber 305 and is attached to the second plate 308. The ink amount measuring sensor 309C is a piezoelectric diaphragm and attached to the ink casing 300 (refer to FIG. 5B) . In addition, a method of measuring the amount of the ink is not limited thereto, and an optical ink amount measuring sensor or a buoy may be used.

As illustrated in FIG. 6, the ink circulating device 3 includes air chambers above an ink liquid surface a of the ink I in the collection side ink chamber 306, and above an ink liquid surface b of the ink I in the supply side ink chamber 305. The ink circulating device 3 includes a pressure sensor 310 for detecting air pressure of the air in the supply side ink chamber 305 and the air in the collection side ink chamber 306 (refer to FIG. 5B). In addition, the pressure sensor 310 includes two pressure detection ports on one chip, and detects the pressure of the two ink chambers (the supply side ink chamber 305 and the collection side ink chamber 306) in the ink casing 300.

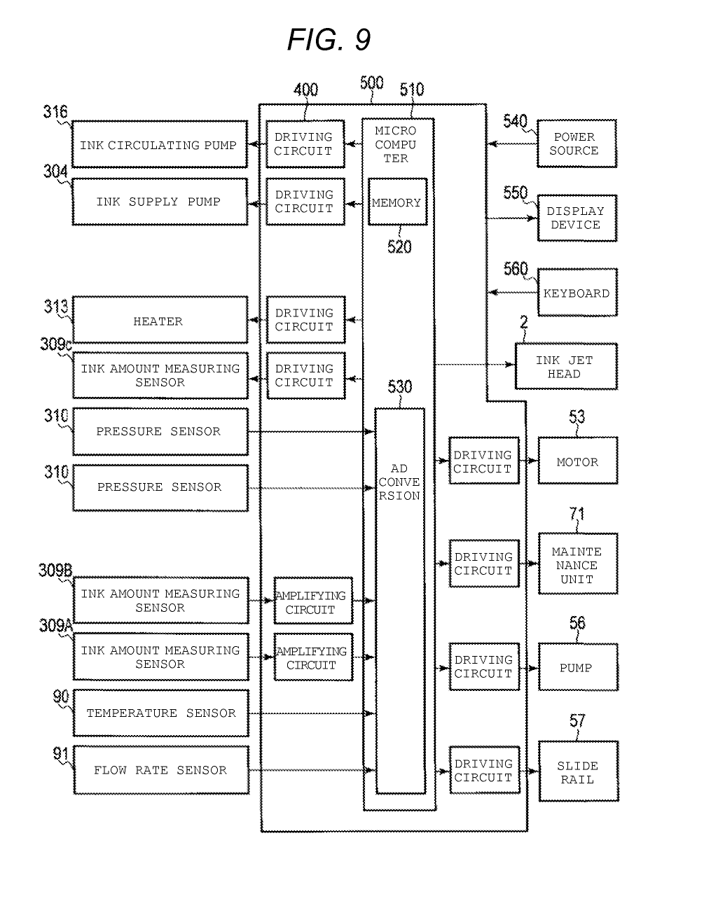

In this manner, the pressure sensor 310 may measure the pressure of the air in the two ink chambers. The pressure sensor 310 outputs the pressures in the supply side ink chamber 305 and the collection side ink chamber 306 as electric signals, and transfers the signals to a control unit 500 (refer to FIG. 9).

The ink circulating device 3 includes a heater 313 for adjusting viscosity of the ink in the ink casing 300, outside the collection side ink chamber 306. The heater 313 is attached to the ink casing 300 by an adhesive having high heat conductivity.

Hereinafter, each configuration will be described in detail.

The ink supply pump 304 illustrated in FIGS. 5 and 6 is attached to an outer wall of the ink circulating device 3 of the ink jet unit 4. The tube 42 which sends the ink I to the ink circulating device 3 from the ink cartridge 41 is connected to the ink replenishing port 315 of the supply side ink chamber 305. The ink supply pump 304 supplies the ink I to the supply side ink chamber 305 from the ink cartridge 41.

The ink supply pump 304 is a piezoelectric pump. The ink supply pump 304 periodically changes a capacity in the pump and conveys the ink I as the piezoelectric diaphragm having a piezoelectric element and a metal plate stacked on each other deforms.

As illustrated in FIG. 5B, an ink circulating pump 316 is disposed on a surface opposite to the first plate 307 (refer to FIG. 5A) which covers the collection side ink chamber 306 and the second plate 308 (refer to FIG. 5A) which covers the supply side ink chamber 305. The control unit 500, which includes a control unit 510, is disposed to cover the ink circulating pump 316 in the ink jet unit 4. The control unit 500 controls the ink circulating pump 316, the ink supply pump 304, the pressure adjusting unit 303, and the like.

The ink circulating pump 316 sucks the ink I from a suction hole 320 of the collection side ink chamber 306, and makes the ink I flow into the supply side ink chamber 305 from a discharge hole 322 (refer to FIGS. 6 and 8). Inner pressure of the supply side ink chamber 305, which is tightly closed, increases as the amount of the ink increases, and the ink I flows into the ink jet head 2 through the ink supply pipe 301 (refer to FIG. 6).

The ink casing 300 includes the supply side ink chamber 305 from which the ink I is supplied to the ink jet head 2 via the ink supply pipe 301, and the collection side ink chamber 306 into which the ink I is recovered from the ink jet head 2 via the ink returning pipe 302. A housing of the ink casing 300 is formed of aluminum. The supply side ink chamber 305 is formed by fixing the first plate 307 made of a resin to a frame unit which forms the supply side ink chamber with an adhesive. Similarly, the collection side ink chamber 306 is formed by fixing the second plate 308 made of a resin to a frame unit which forms the collection side ink chamber 306 with an adhesive. In addition, as a material of the first plate 307 and the second plate 308, a polyimide resin is used.

The ink casing 300 may be formed of metal or resin in addition to aluminum, if the material does not change a quality of the ink I. Stainless steel or brass maybe used as the metal, and ABS (acrylonitrile butadiene styrene), an epoxy resin, or polycarbonate may be used as the resin. In addition, instead of the polyimide resin, PET (polyethylene terephthalate), polyamide, aluminum, stainless steel, or brass may be used as the materials of the first plate 307 and the second plate 308.

As illustrated in FIG. 5A, the collection side ink chamber 306 and the supply side ink chamber 305 are integrally formed sharing a common wall 323 as a partition. An arranging direction of the collection side ink chamber 306 and the supply side ink chamber 305 is the same direction as a nozzle arranging direction (longitudinal direction (B direction) of the ink jet head 2) of the ink jet head 2. In other words, the arranging direction of the collection side ink chamber 306 and the supply side ink chamber 305, which are located above the ink jet head 2, is arranged in a direction substantially orthogonal to a scanning direction of the carriage 51.

There are following two reasons why the collection side ink chamber 306 and the supply side ink chamber 305 are arranged in the direction substantially perpendicular to the scanning direction of the carriage 51. First, the speed of the carriage 51 increases or decreases when the carriage 51 starts or stops scanning. When the speed of the carriage 51 increases or decreases, the ink liquid surface a and the ink liquid surface b in the collection side ink chamber 306 and the supply side ink chamber 305 vibrate. The vibration of the ink liquid surface a and the ink liquid surface b is generated substantially equivalently to each other since the collection side ink chamber 306 and the supply side ink chamber 305 are arranged in the direction which is substantially perpendicular to the scanning direction. Since a difference in vibration of the ink liquid surface a and the ink liquid surface b is small, the meniscus 67 of the ink jet head 2 which is in the middle between the collection side ink chamber 306 and the supply side ink chamber 305 little changes. For this reason, the change of the meniscus 67 is small, and the ink jet head 2 may stably eject the ink I from the nozzles 62 even when the speed of the carriage 51 increases or decreases.

Second, five ink jet units 4 including the ink jet units 4(a) to 4(e) are arranged in the scanning direction of the carriage 51 in the ink jet device 1. In other words, the collection side ink chamber 306 and the supply side ink chamber 305 are arranged in the direction substantially perpendicular to the scanning direction of the carriage 51. In the ink jet device 1, compared to the ink jet device in which the collection side ink chamber 306 and the supply side ink chamber 305 are arranged in the same direction as the scanning direction of the carriage 51, the width of the carriage 51 in the scanning direction may be narrowed, and as a result the ink jet device 1 may be miniaturized.

The ink casing 300 includes the outlet 350 and the inlet 348. The ink I is introduced into the outlet 350 from the collection side ink chamber 306 by the ink circulating pump 316. The inlet 348 of the supply side ink chamber 305 is connected to the discharge hole 322 of the ink circulating pump 316, and the ink I is supplied to the supply side ink chamber 305 through the inlet 348 (refer to FIG. 6). The collection side ink chamber 306 and the supply side ink chamber 305 are adjacent to each other via the common wall 323 (refer to FIGS. 5A and 6). The ink circulating pump 316 is provided across the collection side ink chamber 306 and the supply side ink chamber 305 which are adjacent to each other (refer to FIGS. 5B and 6). The inlet 348 includes a filter 351 at a position at which the ink I flows before flowing into the supply side ink chamber 305. The filter 351 removes foreign substances from the ink I that flows from the collection side ink chamber 306. As a material of the filter 351, a mesh filter, such as polypropylene, nylon, polyphenylene sulfide, or stainless steel, may be used.

As illustrated in FIG. 8, a first ink communication path 319 of an ink circulating pump 316 is connected to the outlet 350 at the suction hole 320. In addition, a second ink communication path 321 of the ink circulating pump 316 is connected to the inlet 348 at the discharge hole 322 (refer to FIG. 8). The first ink communication path 319 and the second ink communication path 321 are arranged substantially perpendicular to the plate surface of the plate-shaped ink circulating pump 316. The second ink communication path 321 is connected to the collection side ink chamber 306 and substantially parallel thereto. The second ink communication path 321 is connected to the supply side ink chamber 305 and substantially parallel to each other. The ink I is conveyed from the collection side ink chamber 306 to the supply side ink chamber 305 through the first ink communication path 319 and the second ink communication path 321 of the ink circulating pump 316.

In the present embodiment, the first ink communication path 319 and the second ink communication path 321 are provided in the ink circulating pump 316. Alternatively. the first ink communication path 319 and the second ink communication path 321 may be provided in the ink casing 300. In addition, in order to miniaturize the ink circulating device 3, the length of the first ink communication path 319 and the second ink communication path 321 may be shortened.

The ink circulating pump 316 is a piezoelectric pump which is similar to the above-described ink supply pump 304. A configuration of the piezoelectric pump which is provided in the ink supply pump 304 and the ink circulating pump 316 will be described in detail. Here, since the configurations of the ink supply pump 304 and the ink circulating pump 316 are the same as each other, the configuration of the ink circulating pump 316 will be described as an example.

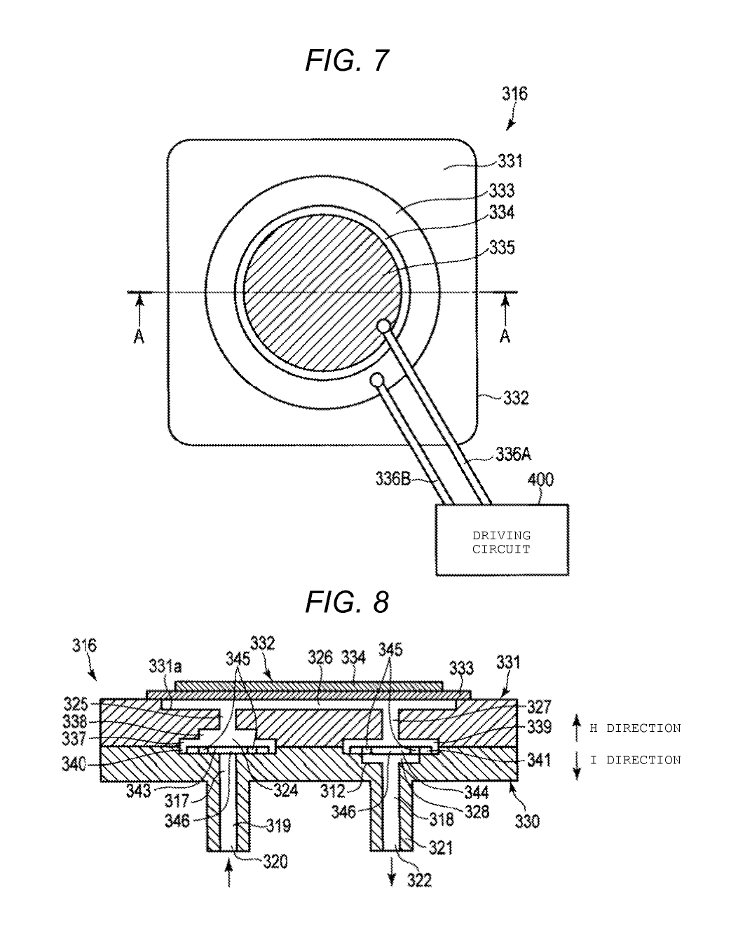

FIG. 7 illustrates an external shape of the piezoelectric pump (hereinafter, will be simply referred to as a piezoelectric pump) of the ink circulating pump 316 which is connected to a driving circuit 400 of the present embodiment. FIG. 8 illustrates a sectional view of the piezoelectric pump cut along line A-A of FIG. 7.

As illustrated in FIG. 8, the ink circulating pump 316 includes a lower housing 330, an upper housing 331, and a piezoelectric actuator 332. By combining the lower housing 330 and the upper housing 331 with each other, a suction chamber 324 and a liquid sending chamber 328 are formed.

An ink suction side of the ink circulating pump 316 includes an inlet 317 into which the ink I flows, the suction chamber 324 (first liquid chamber) which communicates with the inlet 317, and a first communication hole 325 which communicates with the suction chamber 324. A first check valve 343 is formed between the inlet 317 and the suction chamber 324. The first communication hole 325 communicates with a pump chamber 326 (third liquid chamber). The pump chamber 326 communicates with the liquid sending chamber 328 (second liquid chamber) via a second communication hole 327. The liquid sending chamber 328 communicates with a liquid sending port 318 via a second check valve 344.

For example, the upper housing 331 is made of a PPS (polyphenylene sulfide) resin having a diameter of 40 mm and a thickness of 3 mm, and includes a recessed portion 331a having a diameter of 30 mm and a depth of 0.1 mm on an upper unit thereof (refer to FIG. 8). The pump chamber 326 is formed by fixing a metal plate 333 of the piezoelectric actuator 332 to the upper housing 331 with an adhesive, so as to cover the recessed portion 331a.

On a side of the upper housing 331 opposite to a side having ∘ the recessed portion 331a, a rectangular first recessed portion 337 and a rectangular second recessed portion 338 are formed. The rectangular first recessed portion 337 forms the suction chamber 324, and the rectangular second recessed portion 338 which has the same center as that of the first recessed portion 337 and has a smaller surface area than that of the first recessed portion 337, are arranged in a shape of steps.

The suction chamber 324 communicates with the pump chamber 326 via the first communication hole 325 which passes through the upper housing 331 and has the same center as that of the second recessed portion 338.

On a side of the upper housing 331 opposite to a side having the recessed portion 331a, a rectangular third recessed portion 339 that forms the liquid sending chamber 328 is formed. The liquid sending chamber 328 communicates with the pump chamber 326 via the second communication hole 327 which passes through the upper housing 331 and has the same center as that of the third recessed portion 339.

For example, the lower housing 330 is made of a PPS (polyphenylene sulfide) resin having a diameter of 40 mm and a thickness of 3 mm. A surface of the lower housing 330 which faces the upper housing 331 has the same center as that of the first recessed portion 337 and has a rectangular fourth recessed portion 340 that forms the suction chamber 324. The suction chamber 324 is formed of the first recessed portion 337, the second recessed portion 338, and the fourth recessed portion 340. The fourth recessed portion 340 communicates with the first ink communication path 319 which has the same center as that of the first communication hole 325. The ink I is sucked into the suction chamber 324 through the first ink communication path 319.

Furthermore, a rectangular fifth recessed portion 341 that forms the liquid sending chamber 328 is formed on the same surface as that of the fourth recessed portion 340 of the lower housing 330. The rectangular fifth recessed portion 341 that forms the liquid sending chamber 328, and a rectangular sixth recessed portion 342 which has the same center as that of the fifth recessed portion 341 and has a smaller surface area than that of the fifth recessed portion 341 are arranged in a shape of steps. The sixth recessed portion 342 communicates with the second ink communication path 321 when the center of the sixth recessed portion 342 is the same as that of the second communication hole 327.

The suction chamber 324 includes the first check valve 343. The first check valve 343 has an angulated shape and is made of polyimide. The first check valve 343 has a rectangular shape which is slightly smaller than that the suction chamber 324. A hole (slit) 345 is formed in the first check valve 343, so that a check valve circular unit 346 made of polyimide remains at the center thereof.

The first check valve 343 vertically moves in a height direction (L or H direction) when the ink I which flows to the first communication hole 325 from the inlet 317 in the suction chamber 324 (refer to FIG. 8). At this time, the ink I flows toward the first communication hole 325 from the inlet 317, but the flow in a reverse direction is regulated.

In addition, the liquid sending chamber 328 includes the second check valve 344 which has the same structure as that of the first check valve 343. The liquid sending chamber 328 has a configuration which is reversed with respect to a flowing direction of the ink I with the same shape and size as those of the suction chamber 324. The second check valve 344 vertically moves in the height direction (H or L direction) when the ink I which flows through the liquid sending port 318 from the second communication hole 327 into the liquid sending chamber 328. At this time, the ink I flows toward the liquid sending port 318 from the second communication hole 327, but the flow in the reverse direction is regulated.

Next, the piezoelectric actuator 332 will be described. As illustrated in FIG. 7, the piezoelectric actuator 332 includes the metal plate 333, a piezoelectric ceramic 334 which is fixed onto the metal plate 333, and a silver paste 335 which functions as an electrode. The silver paste 335 is applied on the metal plate 333. For example, the metal plate 333 is made of stainless steel having a diameter of 30 mm and a thickness of 0.2 mm. A surface on the pump chamber 326 side of the metal plate 333 forms a coating film on the surface by a resin. The coating film is provided to prevent the metal plate 333 and liquid from being in contact with each other. For example, the piezoelectric ceramic 334 is PZT (lead zirconate titanate) having a diameter of 25 mm and a thickness of 0.25 mm. The piezoelectric ceramic 334 is polarized in a thickness direction, expands and contracts in a direction of the surface when an electric field is applied in the thickness direction, and makes the pump chamber 326 extend and contract. The electrode (silver paste) 335 on the piezoelectric ceramic 334 and the metal plate 333 are connected to the driving circuit 400 through wirings 336A and 336B.

In an operation (first operation) which sends the ink I, the driving circuit 400 operates the piezoelectric actuator 332 at 100 Hz of frequency and 100 V of AC voltage. The piezoelectric actuator 332 makes the pump chamber 326 expand and contract, and sends the ink I.

As a material of the metal plate 333, instead of stainless steel, nickel, brass, gold, silver, or copper maybe used. As a material of the piezoelectric ceramic 334, instead of PZT, PTO (PbTiO3: lead titanate), PMNT (Pb(Mg1/3Nb2/3)O3-PbTiO3), PZNT (Pb(Zn1/3Nb2/3)O3-PbTiO3), ZnO, or AlN may be used. An operation is possible when an operating voltage of the piezoelectric actuator 332 is in a range of AC 1 mV to AC 200 V, and a frequency is in a range of 1 mHz to 200 Hz. The piezoelectric actuator 332 may appropriately adjust a driving voltage and a driving frequency in accordance with the viscosity of the ink I and a conveying amount of the ink I.

First, an operation to suck the ink I from the inlet 317 by the ink circulating pump 316 will be described.

The driving voltage is applied to the piezoelectric actuator 332 by a driving signal from the driving circuit 400. The piezoelectric actuator 332 expands towards the outside and expands a capacity of the pump chamber 326. The ink I flows into the suction chamber 324 through the first ink communication path 319 as inner pressure decreases according to the expansion of the capacity of the pump chamber 326. The first check valve 343 is lifted up in the H direction by the flowed-in ink I. The first check valve 343 which is lifted up in the H direction remains in the second recessed portion 338. The ink I flows into the pump chamber 326 through the hole 345 of the first check valve 343. In addition, at this time, the second check valve 344 moves to the third recessed portion 339 as the inner pressure decreases according to the expansion of the capacity of the pump chamber 326, and blocks the second communication hole 327.

Next, an operation to discharge the ink I from the liquid sending port 318 by the ink circulating pump 316 will be described.

The driving voltage is applied by the driving signal from the driving circuit 400, and the piezoelectric actuator 332 contracts towards the inside and reduces the capacity of the pump chamber 326. The ink I flows into the liquid sending chamber 328 from the second communication hole 327 as the inner pressure of the pump chamber 326 increases according to a decrease in the capacity of the pump chamber 326. The second check valve 344 moves in the L direction by the flowed-in ink I, and remains in the sixth recessed portion 342. The ink I is sent to the second ink communication path 321 through the hole 345 of the second check valve 344. In addition, at this time, the first check valve 343 moves to the fourth recessed portion 340 as the inner pressure of the pump chamber 326 increases according to the decrease in the capacity of the pump chamber 326, and blocks the inlet 317.

By repeating the above-described operations, the ink I flows in one direction to the liquid sending chamber 328 from the suction chamber 324.

When the ink circulating pump 316 having the above-described configuration is operated, the ink I is sucked through the suction hole 320 from the collection side ink chamber 306, and is conveyed to the supply side ink chamber 305 through the discharge hole 322 (refer to FIG. 6). In the supply side ink chamber 305 which is tightly closed, the inner pressure increases as the amount of the ink increases, and the ink I flows into the inkjet head 2 through the ink supply pipe 301 (refer to FIG. 6).

In the present embodiment, as a material of the first check valve 343 and the second check valve 344, polyimide is used. The reason why polyimide is used is that polyimide is tolerant of various types of ink, such as water-based ink, oil-based ink, ink of volatile solvent, or UV ink that are used in the ink jet device 1. In addition, the material of the first check valve 343 and the second check valve 344 has rigidity which is equal to or greater than 1×107 [Pa] in Young's modulus. The check valve which has rigidity that is equal to or greater than 1×107 [Pa] in Young's modulus may convey the ink I through the hole 345 in the suction chamber 324 and the liquid sending chamber 328, and open and close the inlet 317, the liquid sending port 318, the first communication hole 325, and the second communication hole 327. In addition, as the material of the first check valve 343 and the second check valve 344, instead of polyimide, a resin or a metal which has high ink resistance, such as PET (polyethylene terephthalate), PE (polyethylene) having an ultrahigh molecular weight, PP (polypropylene), PPS (polyphenylene sulfide), PEEK (polyetheretherketone), PFA (tetrafluoroethylene perfluoroalkylvinylether copolymer), FEP (fluorinated ethylene propylene), ETFE (ethylene tetrafluoroethylene copolymer), PTFE (polytetrafluoroethylene), aluminum, stainless steel, or nickel, may be used. The material of the first check valve 343 and the second check valve 344 is not limited to the same material, and a resin or a metal among the above-described resins or metals may be selected and appropriately used.

FIG. 9 is a block diagram of the control unit 500 which controls the operation of the ink jet device 1. A power source 540, a display device 550 which displays a state of the ink jet device 1, and a keyboard 560 which serves as an input device, are connected to the control unit 500. The control unit 500 includes a microcomputer 510 (hereinafter, referred to as a control unit 510) which is the center of controlling of the ink jet device 1, a memory 520 which stores a program, and an AD conversion unit 530 which receives an output voltage of the pressure sensor 310, the temperature sensor 90, or the flow rate sensor 91 therein. Furthermore, the control unit 500 includes a plurality of driving circuits 400, and operates the motor 53 which relatively moves the ink jet unit 4 with respect to medium S, the slide rail 57, the ink circulating pump 316, the ink supply pump 304, the pump 56, the heater 313, and the like.

When the ink jet device 1 is initially operated to perform printing, it is necessary to fill the ink circulating device 3 and the ink jet head 2 with the ink I from the ink cartridge 41. Specifically, for example, the ink circulating device 3 and the ink jet head 2 of the ink jet unit 4(a) is filled with the cyan ink supplied from the ink cartridge 41(a). Similarly, the ink jet units 4(b) to 4(e) are respectively filled with the magenta ink, the yellow ink, the black ink, and the white ink supplied from the ink cartridges 41(b) to 41(e). When an initial filling operation is commanded from the keyboard 560, the control unit 510 operates in the following order.

The control unit 510 controls the ink jet unit 4 to return to the waiting position, and covers the nozzle plate 61 by raising the maintenance unit 71. The control unit 510 drives the ink supply pump 304, and sends the ink I to the supply side ink chamber 305 from the ink cartridge 41 together with the air in the tube 42.

When the ink amount measuring sensor 309B of the supply side ink chamber 305 detects that a level of the ink I moves up to the discharge hole 322, the control unit 510 starts adjusting the pressure in the ink casing 300 using the pressure adjusting unit 303, and at the same time, drives the ink circulating pump 316 for a predetermined time. The adjustment of the pressure in the ink casing 300 is performed by the pressure adjusting unit 303. The pressure adjusting unit 303 sends the air to each of the supply side ink chamber 305 and the collection side ink chamber 306, and increases the pressure in the ink casing 300. To the contrary, the pressure adjusting unit 303 may release the air to the outside from the supply side ink chamber 305 and the collection side ink chamber 306, and reduce the pressure in the ink casing 300. The control unit 510 adjusts the pressure in the ink casing 300 using the above-described pressure adjusting unit 303. Here, a state of the pressure in the supply side ink chamber 305 and the collection side ink chamber 306 is detected by the pressure sensor 310.

The pressure sensor 310 is, for example, a semiconductor piezoresistive sensor and outputs the pressure of the supply side ink chamber 305 and the collection side ink chamber 306 as electric signals. The semiconductor piezoresistive sensor includes a diaphragm which receives pressure from the outside and a semiconductor strain gauge which is formed on the surface of the diaphragm. The semiconductor piezoresistive sensor detects the pressure by converting the change in the electric resistance into the electric signal by a piezoresistive effect which is generated by a strain gauge according to the deformation in the diaphragm due to the pressure. The ink I is supplied to the supply side ink chamber 305 via the ink circulating pump 316 from the collection side ink chamber 306. The control unit 510 performs detection of the amount of the ink of the collection side ink chamber 306 and the supply side ink chamber 305 using the ink amount measuring sensors 309A and 309B. The control unit 510 finishes to supply the ink I when the level of the ink I reaches the suction hole 320 and the discharge hole 322 of the ink circulating pump 316.

When the level of the ink in the collection side ink chamber 306 is below a specific level, the control unit 510 drives the ink supply pump 304, and continues to supply the ink I to the supply side ink chamber 305 from the ink cartridge 41. When the ink amount measuring sensor 309B detects that the ink I flows up to the suction hole 320, the control unit 510 starts adjusting the pressure in the ink casing 300 by the pressure adjusting unit 303, and drives the ink circulating pump 316 for a predetermined time. By repeating the operation, the control unit 510 adjusts the amount of the ink of the collection side ink chamber 306 and the supply side ink chamber 305 of the ink circulating device 3, and finishes the initial filling operation. In addition, the ink jet device 1 maintains a state where the ink casing 300 is tightly closed even when the power source is turned off. As the meniscus 67 of the nozzles 62 is maintained, the ink I does not leak from the nozzles 62.

Next, a printing operation will be described. For example, when the printing operation is commanded, the control unit 510 controls the maintenance unit 71 to move apart from the nozzle plate 61. The control unit 510 adjusts the pressure in the collection side ink chamber 306 using the pressure adjusting unit 303. The control unit 510 drives the ink circulating pump 316, and causes the ink I to be supplied to the ink circulating pump 316, the supply side ink chamber 305, the ink jet head 2, and the collection side ink chamber 306 in order from the collection side ink chamber 306.

When the height of the ink liquid surface a and the ink liquid surface b which is detected by the ink amount measuring sensors 309A and 309B of the supply side ink chamber 305 and the collection side ink chamber 306 is not the desired height, the control unit 510 drives the ink supply pump 304. The control unit 510 drives the ink supply pump 304, and supplies the ink I to the supply side ink chamber 305 from the ink cartridge 41 until the height of the liquid surface of the ink I becomes the desired height.

The control unit 510 energizes the heater 313. The control unit 510 measures the temperature of the ink in the vicinity of the ink inlet of the ink jet head using the temperature sensor 90. When the measured temperature of the ink I is lower than the range of an appropriate temperature for ejection, the ejection speed of the ink is adjusted. When the temperature of the ink I reaches the appropriate temperature for ejection, the control unit 510 controls energization of the heater 313, such that the temperature of the ink is in a predetermined range. Example of the temperature sensor 90 includes a thermocouple, a temperature measuring resistor, or a thermistor.

Here, the appropriate temperature for ejecting the ink is a temperature which is appropriate for stably ejecting the ink, which is determined separately for each type of the ink. The appropriate temperature for ejecting the ink is input by the keyboard 560 for each type of the ink in advance. For example, the ink is controlled within a range of approximately ±5° C. according to the set value by the heater 313 provided in the collection side ink chamber 306.

Next, the control unit 510 synchronizes the ink jet head 2 to the scanning of the carriage 51, and ejects the ink I to the medium S in accordance with image data to be printed. The control unit 510 controls the slide rail 57, and moves the medium S at a predetermined distance. The control unit 510 repeats the operation of synchronizing the ink jet head 2 to the scanning of the carriage 51, and discharging the ink I, and forms the image on the medium S.

The pressure sensor 310 detects the decrease in the pressure in the collection side ink chamber 306 by ejecting the ink I from the ink jet head 2. When it is detected that the pressure in the collection side ink chamber 306 decreases, the control unit 510 drives the pressure adjusting unit 303, and sends the ink I as much as the amount of the ink which is ejected by driving the ink supply pump 304, to the collection side ink chamber 306.

The printing operation when the initial printing is performed will be described.

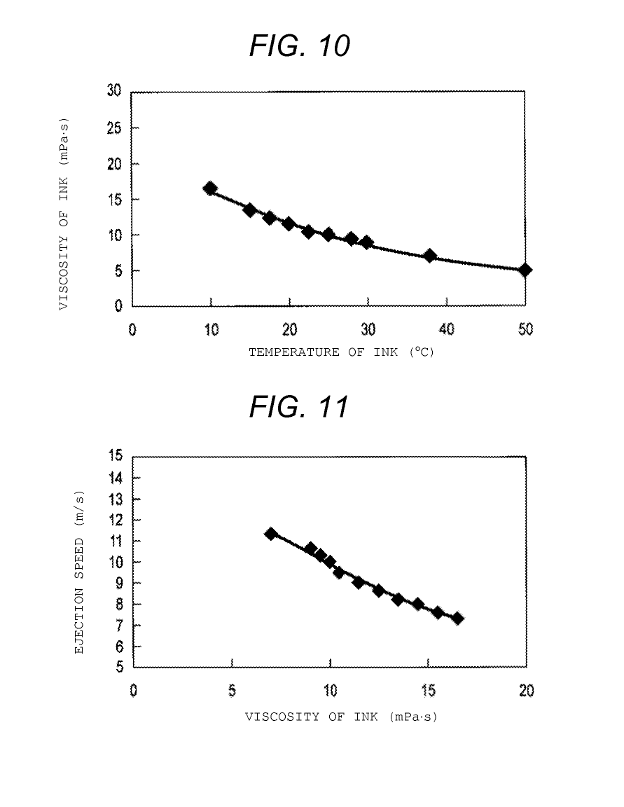

The ink which is used in the inkjet device is generally liquid. For this reason, the viscosity of the ink changes according to the temperature of the ink. FIG. 10 illustrates a relationship between the temperature of the ink and the viscosity of the ink. According to FIG. 10, the viscosity of the ink decreases as the temperature of the ink increases, and increases as the temperature of the ink decreases. In addition, as illustrated in FIG. 11, according to the increase in the viscosity of the ink, the ejection speed of the ink decreases.

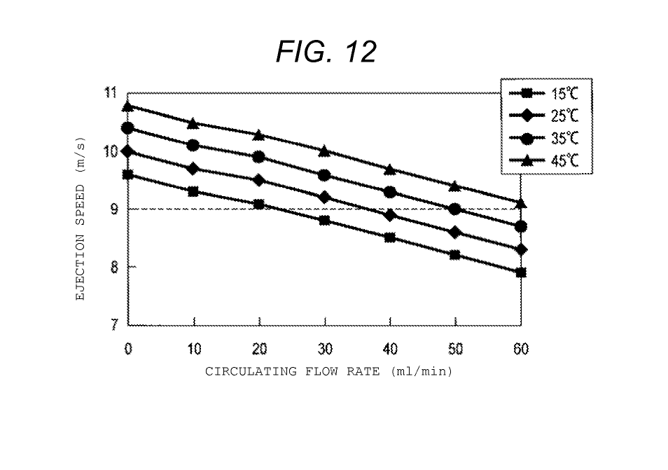

In addition, when a relationship between a circulating flow rate (ml/min) and the ejection speed (m/s) in each level of the temperature of the ink (15° C., 25° C., 35° C., 45° C.) is examined as illustrated in FIG. 12, the ejection speed of the ink is inversely proportional to the circulating flow rate of the ink. In other words, the ejection speed of the ink decreases according to the increase in the circulating flow rate of the ink. In the present embodiment, the ink which is oil-based and has viscosity of approximately 10 mPa·s (25° C.) is used.

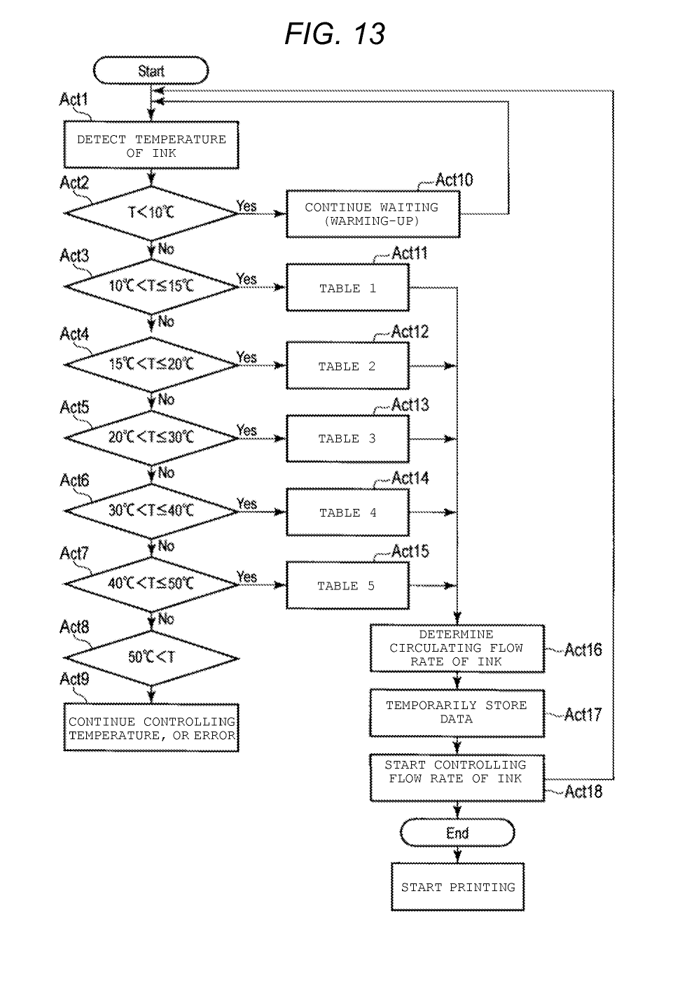

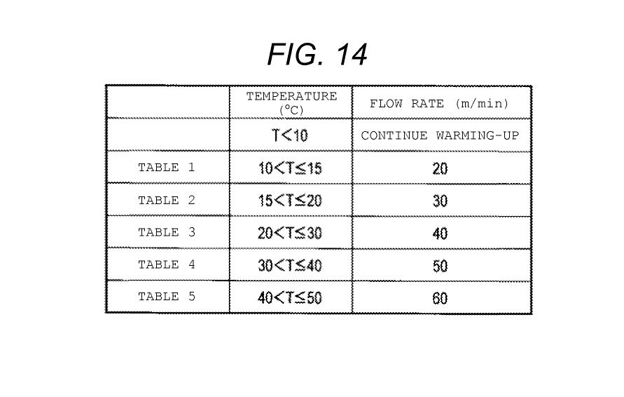

Next, a control of the circulating amount of the ink in the ink circulating device 3 when the temperature of the ink of the ink jet device 1 is lower than the appropriate temperature for ejection, will be described with reference to a flow chart of FIG. 13 and a control table of FIG. 14. In addition, in the present embodiment, the ejection speed of the ink I is 9 m/s at which a smear or the like of the image is not generated when printing is performed.

After completing the initial filling operation, the control unit 510 recognizes a temperature T of the ink I using the temperature sensor 90 which is provided in the vicinity of the ink inlet of the ink jet head 2 before the printing operation is performed (Act 1). At this time, when the temperature T of the ink I is equal to or less than 10° C., the process does not proceed to the printing operation, and it is determined that the warming-up is continued (Act 2Y). The control unit 510 continues the warming-up (Act 10). The warming-up is an operation to cause the ink I to circulate between the supply side ink chamber (first tank) 305 and the collection side ink chamber (second tank) 306 using the ink circulating pump 316, which is provided in the ink circulating device 3. In addition, the control unit 510 drives the heater 313 when it is determined that the temperature of the ink I is lower than the appropriate temperature for ejection.

Next, in the middle of continuing the warming-up (Act 10), the control unit 510 recognizes the temperature of the ink I using the temperature sensor 90 every certain period of time (Act 1). For example, when the temperature of the ink I at this time is equal to or greater than 10° C. and less than 15° C. (Act 3Y), the process proceeds to Act 11. Since the control unit 510 controls the ejection speed of the ink to 9 m/s, the flow rate of the ink (20 m/min) illustrated in Table 1 is selected (Act 11). In addition, the control unit 510 determines the circulating flow rate of the ink (Act 16). Next, data of the circulating flow rate of the ink is temporarily preserved (Act 17), and an ink circulating flow rate control of the ink I is started by setting the circulating flow rate of the ink to 20 m/min (Act 18). In addition, the flow rate of the ink is detected by the flow rate sensor 91 which is provided in the ink supply pipe 301 of the ink jet head 2.

In addition, the control unit 510 recognizes the temperature of the ink after a certain period of time is passed (Act 1). The temperature of the ink I increased by the heater 313 which is provided in the collection side ink chamber 306, and the temperature of the ink is further increased. The control unit 510 determines in which range the temperature of the ink is included among the ranges of Act 3 to Act 7. For example, when the temperature of the ink I is equal to or greater than 15° C. and less than 20° C. at this time (Act 3Y), the process proceeds to Act 12. The control unit 510 selects a flow rate (30 m/min) illustrated in Table 2 from the control table. In addition, the control unit 510 determines the circulating flow rate of the ink based on this table (Act 16). The control unit 510 temporarily stores the data of the circulating flow rate of the ink (Act 17), and starts ejecting the ink I by setting the circulating flow rate of the ink to 30 m/min. After this process, the control unit 510 controls the flow rate of the ink in an order which is similar to the above-described order in accordance with an increase in the temperature of the ink, and stably ejects the ink I.

Values of the control table which determines the circulating flow rate of the ink illustrated in FIG. 14 are obtained by performing a test in advance for each used ink separately. In addition, the relationship between the driving voltage of the ink circulating pump to circulate the ink and the circulating flow rate of the ink is also obtained by performing a test in advance.

According to the present embodiment, even at the temperature of the ink at which the printing operation cannot be executed, the control unit 510 may perform the printing. In other words, generally, printing is possible when the ink is conventionally subject to a warming-up operation. Furthermore, using the control table as illustrated in FIG. 14, the control unit 510 may control the circulating flow rate of the ink by the temperature of the ink step by step in a process of gradually increasing the temperature of the ink during the warming-up. As a result, the control unit 510 may stabilize the ejection speed of the ink. Therefore, the ink jet device 1 according to the present embodiment may drastically shorten the warming-up time while maintaining the ejection speed of the ink.

While certain embodiments have been described, these embodiments have been presented by way of example only, and are not intended to limit the scope of the inventions. For example, in the embodiment, as a device which changes the temperature of the ink, a heater is described, but in addition to the heater, the cooling device (cooler) may be provided. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet apparatus, comprising:
a head configured to discharge liquid through a plurality of nozzles;
a tank configured to store the liquid;
a circulation device positioned between the tank and the head and including a supply passage by which the liquid is circulated from the tank to the head and a return passage by which the liquid is circulated from the head to the tank;
a temperature detecting unit configured to detect a temperature of the circulated liquid; and
a control unit configured to control a flow rate of the circulated liquid, based on a detection result of the temperature detecting unit.

2. The inkjet apparatus according to claim 1, further comprising:
a heating unit configured to heat the circulated liquid.

3. The inkjet apparatus according to claim 1, wherein
the tank includes a first chamber into which the liquid is recovered from the head and a second chamber from which the liquid is supplied to the head, and
the heating unit is disposed on a wall of the first chamber.

4. The inkjet apparatus according to claim 1, further comprising:
a storage unit configured to store a relationship between the temperature of the circulated liquid and the flow rate of the circulated liquid, wherein
the control unit controls the flow rate by referring to the relationship.

5. The inkjet apparatus according to claim 1, wherein
when a temperature detected by the temperature detecting unit increases, the flow rate of the liquid is controlled to be lower.

6. The inkjet apparatus according to claim 1, wherein
the temperature detecting unit is disposed along a flow path of the liquid between the tank and the head.

7. The inkjet apparatus according to claim 1, further comprising:
a flow rate detecting unit, wherein
the control unit controls the flow rate further based on a detection result of the flow rate detecting unit.

8. The inkjet apparatus according to claim 7, wherein
the flow rate detecting unit is located along a flow path of the liquid between the tank and the head.

9. The inkjet apparatus according to claim 1, wherein
the control unit controls the flow rate, such that a discharging speed of the liquid from the nozzles is constant even as a temperature of the circulated liquid changes.

10. An inkjet apparatus, comprising:
a head configured to discharge liquid through a plurality of nozzles;
a tank configured to store the liquid;
a circulation device positioned between the tank and the head and including a supply passage by which the liquid is circulated from the tank to the head and a return passage by which the liquid is circulated from the head to the tank;
a heating unit configured to heat the circulated liquid; and
a control unit configured to control a discharging speed of the liquid discharged from the nozzles to be constant even as a temperature of the circulated liquid changes.

11. The inkjet apparatus according to claim 10, wherein the tank includes a first chamber into which the liquid is recovered from the head and a second chamber from which the liquid is supplied to the head, and
the heating unit is located at a wall of the first chamber.

12. The inkjet apparatus according to claim 10, wherein
the control unit controls the discharging speed, by controlling a flow rate of the liquid circulated by the circulation device.

13. The inkjet apparatus according to claim 12, wherein
when a temperature of the circulated liquid increases, the flow rate of the liquid is controlled to be lower.

14. The inkjet apparatus according to claim 10, further comprising:
a temperature detecting unit configured to detect a temperature of the circulated liquid.

15. The inkjet apparatus according to claim 14, wherein
the temperature detecting unit is located along a flow path of the liquid between the tank and the head.

16. The inkjet apparatus according to claim 10, further comprising:
a flow rate detecting unit, wherein
the control unit controls the flow rate further based on a detection result of the flow rate detecting unit.

17. The inkjet apparatus according to claim 16 wherein
the flow rate detecting unit is located along a flow path of the liquid between the tank and the head.

18. A printing apparatus, comprising:
a sheet conveying unit configured to convey a sheet;
an inkjet unit including:
a head configured to discharge liquid through a plurality of nozzles,
a tank configured to store the liquid,
a circulation device positioned between the tank and the head and including a supply passage by which the liquid is circulated from the tank to the head and a return passage by which the liquid is circulated from the head to the tank, and
a temperature detecting unit configured to detect a temperature of the liquid;
a moving unit configured to move the inkjet unit as the sheet is conveyed; and
a control unit configured to control a flow rate of the liquid circulated by the circulation device, based on a detection result of the temperature detecting unit.

19. The printing apparatus according to claim 18, wherein
the inkjet unit further includes a heating unit configured to heat the circulated liquid.

20. The printing apparatus according to claim 19, wherein
the control unit controls the flow rate, such that a discharging speed of the liquid from the nozzles is constant even as a temperature of the circulated liquid changes.
